(19) United States
(12) Patent Application Publication
(10) Pub. No.: US 2009/0180689 A1
(43) Pub. Date: Jul. 16, 2009

(54) COLOR REPRODUCTION DEVICE, COLOR REPRODUCTION METHOD, AND COMPUTER-READABLE RECORDING MEDIUM RECORDED WITH COLOR REPRODUCTION PROGRAM

(75) Inventors: Yasuhiro Komiya, Tokyo (JP); Masanori Mitsui, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 12/345,068

(22) Filed: Dec. 29, 2008

(30) Foreign Application Priority Data
Jan. 11, 2008 (JP) 2008-4195

(51) Int. Cl. G06K 9/00

(52) U.S. Cl. 382/167

(57) ABSTRACT

A color conversion signal, which is determined on the basis of an image signal of the object, color reproduction characteristic information, which is information obtained at the time of image capture of the object, and a spectrum of the observation illumination light is converted into an image signal reflecting a luminance value of the object when observed under the observation illumination light on the basis of the luminance value of the observation illumination light, the luminance value of the imaging illumination light, and the information relating to the light reception condition.

### FIELD OF THE INVENTION

This invention relates to a technique for performing accurate color reproduction processing.

### BACKGROUND OF THE INVENTION

In a known conventional image processing system (see JP2007-209025A), when an image downloaded or displayed by an input side device is output or displayed by an output side device, processing is performed to make the colors of the images on the input side device and the output side device appear identical. In this conventional image processing system, first, image data output from the input side device are converted into XYZ data, and then correction processing is performed in accordance with the visual environment of the input side device and the visual environment of the output side device. The corrected XYZ data are then converted into RGB data and displayed on the output side device.

### SUMMARY OF THE INVENTION

However, although it is possible with this conventional image processing system to perform correction processing corresponding to the illumination spectra of the visual environments of the input and output side devices, it is not possible to reproduce the luminance of an object on the output side device as if observed in the visual environment of the output side device.

According to a first aspect of the present invention, there is provided a color reproduction device comprising an observation illumination light luminance value detection unit that detects a luminance value of an observation illumination light illuminating a monitor device for displaying an image, an imaging illumination light luminance value storage unit that stores a luminance value of an imaging illumination light at the time of image capture of an object by an imaging device, a light reception condition information storage unit that stores information relating to a light reception condition at the time of image capture of the object by the imaging device, and a luminance conversion unit that converts a color conversion signal, which is determined on the basis of an image signal of the object, color reproduction characteristic information, which is information obtained at the time of image capture of the object, and a spectrum of the observation illumination light, into an image signal reflecting a luminance value of the object when observed under the observation illumination light on the basis of the luminance value of the observation illumination light, the luminance value of the imaging illumination light, and the information relating to the light reception condition.

According to a second aspect of the present invention, there is provided a color reproduction device comprising an observation illumination light luminance value detection unit that detects a luminance value of an observation illumination light illuminating a monitor device for displaying an image, an imaging illumination light luminance value storage unit that stores a luminance value of an imaging illumination light at the time of image capture of an object by an imaging device, a light reception condition information storage unit that stores information relating to a light reception condition at the time of image capture of the object by the imaging device, and a luminance conversion unit that converts a color conversion signal, which is determined on the basis of an image signal of the object, color reproduction characteristic information, which is information obtained at the time of image capture of the object, and a spectrum of the observation illumination light, into an image signal reflecting a luminance value of the object when observed under the observation illumination light on the basis of the luminance value of the observation illumination light, a color chart signal, which is a signal obtained when the imaging device captures an image of a color chart having a known spectral reflectance, the spectral reflectance of the color chart, a spectral characteristic of the imaging device, and a spectrum of the imaging illumination light.

According to a third aspect of the present invention, there is provided a color reproduction method comprising obtaining a luminance value of an observation illumination light illuminating a monitor device for displaying an image, obtaining a luminance value of an imaging illumination light at the time of image capture of an object by an imaging device, obtaining information relating to a light reception condition at the time of image capture of the object by the imaging device, and converting a color conversion signal, which is determined on the basis of an image signal of the object, color reproduction characteristic information, which is information obtained at the time of image capture of the object, and a spectrum of the observation illumination light, into an image signal reflecting a luminance value of the object when observed under the observation illumination light on the basis of the luminance value of the observation illumination light, the luminance value of the imaging illumination light, and the information relating to the light reception condition.

According to a fourth aspect of the present invention, there is provided a color reproduction method comprising obtaining a luminance value of an observation illumination light illuminating a monitor device for displaying an image, obtaining a luminance value of an imaging illumination light at the time of image capture of an object by an imaging device, obtaining information relating to a light reception condition at the time of image capture of the object by the imaging device, and converting a color conversion signal, which is determined on the basis of an image signal of the object, color reproduction characteristic information, which is information obtained at the time of image capture of the object, and a spectrum of the observation illumination light, into an image signal reflecting a luminance value of the object when observed under the observation illumination light on the basis of the luminance value of the observation illumination light, a color chart signal, which is a signal obtained when the imaging device captures an image of a color chart having a known spectral reflectance, the spectral reflectance of the color chart, a spectral characteristic of the imaging device, and a spectrum of the imaging illumination light.

According to a fifth aspect of the present invention, there is provided a computer-readable recording medium storing a color reproduction program to be executed on a computer, wherein the color reproduction program comprises obtaining a luminance value of an observation illumination light illuminating a monitor device for displaying an image, obtaining a luminance value of an imaging illumination light at the time of image capture of an object by an imaging device, obtaining information relating to a light reception condition at the time of image capture of the object by the imaging device, and converting a color conversion signal, which is determined on the basis of an image signal of the object, color reproduction characteristic information, which is information obtained at the time of image capture of the object, and a spectrum of the observation illumination light, into an image signal reflecting a luminance value of the object when observed under the observation illumination light on the basis of the luminance value of the observation illumination light, the luminance value of the imaging illumination light, and the information relating to the light reception condition.

According to a sixth aspect of the present invention, there is provided a computer-readable recording medium storing a color reproduction program to be executed on a computer, wherein the color reproduction program comprises obtaining a luminance value of an observation illumination light illuminating a monitor device for displaying an image, obtaining a luminance value of an imaging illumination light at the time of image capture of an object by an imaging device, obtaining information relating to a light reception condition at the time of image capture of the object by the imaging device, and converting a color conversion signal, which is determined on the basis of an image signal of the object, color reproduction characteristic information, which is information obtained at the time of image capture of the object, and a spectrum of the observation illumination light, into an image signal reflecting a luminance value of the object when observed under the observation illumination light on the basis of the luminance value of the observation illumination light, a color chart signal, which is a signal obtained when the imaging device captures an image of a color chart having a known spectral reflectance, the spectral reflectance of the color chart, a spectral characteristic of the imaging device, and a spectrum of the imaging illumination light.

### BRIEF DESCRIPTION OF THE DRAWINGS

FIG. 1 is a view showing the constitution of a color reproduction device according to a first embodiment.

FIG. 2 is a view showing in detail the constitution of a color correction unit.

FIG. 3 is a view showing the constitution of an absolute luminance conversion value calculation unit according to a modified example of the first embodiment.

FIGS. 4A to 4D are views showing various luminance distribution patterns of an image displayed on an image display monitor.

FIG. 5 is a view showing the constitution of a color correction unit of a color reproduction device according to a second embodiment.

FIG. 6 is a view showing a relationship between a pre-adjustment luminance range and a post-adjustment luminance range.

FIG. 7 is a view showing a correspondence relationship between a pre-adjustment luminance value and a post-adjustment luminance value.

FIG. 8 is a view showing the constitution of a color reproduction device according to a third embodiment.

FIG. 9 is a view showing an imaging area of a camera.

FIG. 10 is a view showing the constitution of a color correction unit according to the third embodiment.

FIG. 11 is a pattern diagram showing a luminance correction coefficient C (x, y) calculated by a luminance unevenness correction coefficient calculation unit.

FIG. 12A is a view showing a state in which illumination unevenness occurs in an image display area of an image display monitor when an illumination device is provided to the upper left of the image display monitor, FIG. 12B is a view showing the image prior to luminance correction corresponding to the illumination unevenness, and FIG. 12C is a view showing the image following luminance correction corresponding to the illumination unevenness, which is performed by the color reproduction device according to the third embodiment.

FIG. 13 is a view illustrating a modified example of a constitution for detecting an illumination luminance distribution of the image display area of the image display monitor.

FIG. 14 is a view showing an example in which illumination unevenness in the illumination luminance distribution of the image display area of the image display monitor is detected using a line sensor type illumination sensor.

FIG. 15A is a view showing the orientation of the line sensor when detecting a color reproduction characteristic of the image display monitor, and FIG. 15B is a view showing the orientation of the line sensor when detecting illumination unevenness.

FIG. 16 is a view showing the constitution of a color correction unit in which a luminance adjustment unit and a luminance adjustment value calculation unit are added to the constitution of an illumination condition correction unit of the color correction unit according to the third embodiment, shown in FIG. 10.

FIG. 17 is a flowchart showing a processing procedure of processing that is realized when a CPU executes a color reproduction program.

### DESCRIPTION OF THE PREFERRED EMBODIMENTS

### First Embodiment

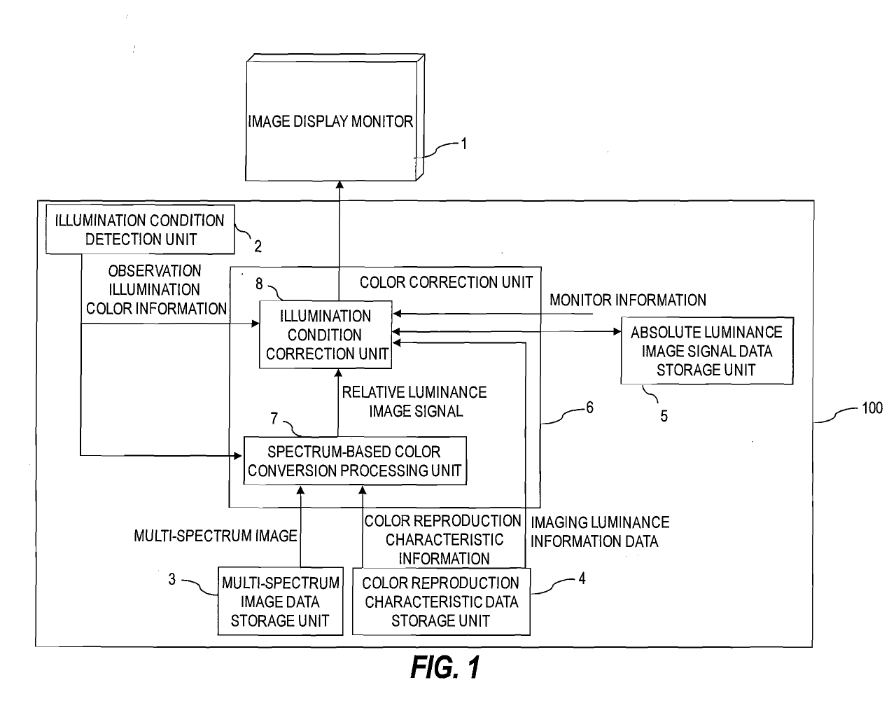

FIG. 1 is a view showing the constitution of a color reproduction device 100 according to a first embodiment. The color reproduction device 100 according to the first embodiment comprises an illumination condition detection unit 2, a multi-spectrum image data storage unit 3 (to be referred to hereafter as storage unit 3), a color reproduction characteristic data storage unit 4 (to be referred to hereafter as storage unit 4), an absolute luminance image signal data storage unit 5 (to be referred to hereafter as storage unit 5), and a color correction unit 6. An image display monitor 1 is an LCD or a plasma monitor, for example, which displays an image that has been subjected to color reproduction processing to be described below by the color reproduction device 100. It should be noted that the term “image” includes both a still image and a moving image.

The illumination condition detection unit 2 detects observation illumination color information, which is information relating to observation illumination light illuminating an observation environment of the image display monitor 1. The observation illumination color information includes information relating to the spectrum and the luminance of the observation illumination light.

The storage unit 3 stores a multi-spectrum image of an object. A multi-spectrum image is a multiband (at least four-band) image, each band having a different spectral sensitivity characteristic, which is obtained through image capture using a camera that is capable of multiple primary color photography, known as a multi-spectrum camera, for example.

The storage unit 4 stores color reproduction characteristic information, which is information relating to a color reproduction characteristic during display of an image on the image display monitor 1, and imaging luminance information. The color reproduction characteristic information is obtained when the multi-spectrum image is captured, and includes data relating to the spectrum of the imaging illumination light at the time of image capture, data relating to the spectral characteristic of the imaging device, statistical data relating to the photographed object, and so on. The imaging luminance information includes a luminance value of the imaging illumination light at the time of image capture of the multi-spectrum image, and a light reception condition coefficient to be described below.

The storage unit 5 stores an image signal generated following color correction processing by the color correction unit 6.

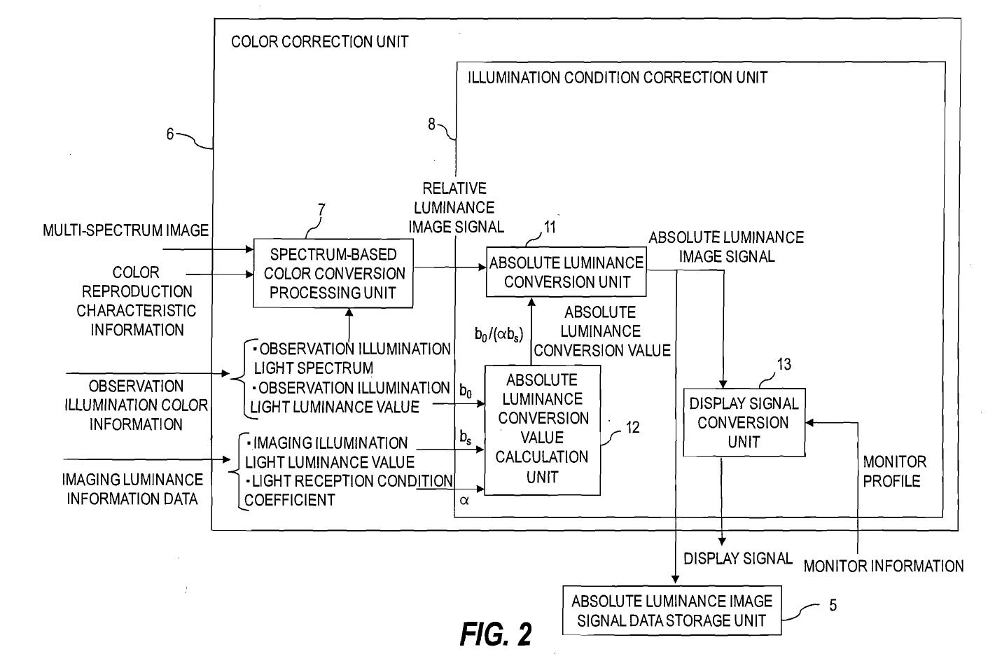

FIG. 2 is a view showing in detail the constitution of the color correction unit 6. The color correction unit 6 comprises a spectrum-based color conversion processing unit 7 (to be referred to hereafter as processing unit 7), and an illumination condition correction unit 8 (to be referred to hereafter as correction unit 8). The correction unit 8 comprises an absolute luminance conversion unit 11 (to be referred to hereafter as conversion unit 11), an absolute luminance conversion value calculation unit 12 (to be referred to hereafter as calculation unit 12), and a display signal conversion unit 13 (to be referred to hereafter as conversion unit 13).

The processing unit 7 determines a color conversion signal represented by an XYZ value of an XYZ colorimetric system, for example, by performing color conversion processing on the multi-spectrum image stored in the storage unit 3 on the basis of the color reproduction characteristic information stored in the storage unit 4 and the spectrum of the observation illumination light detected by the illumination condition detection unit 2. It should be noted that a value of a colorimetric system such as sRGB, Adobe RGB, YCC, or xvYCC, which can be calculated from an XYZ value, may be determined.

Color conversion processing may be performed by the processing unit 7 using a known method. The color conversion signal generated by the color conversion processing reproduces the hues of the object when seen under the observation illumination light. However, luminance information relating to the imaging illumination light and the observation illumination light is not reflected therein. In other words, information relating to the absolute luminance of the object is not reflected, and therefore the color conversion signal generated by the color conversion processing of the processing unit 7 will be referred to in this specification as a relative luminance image signal. Accordingly, in the specification and claims, the terms “color conversion signal” and “relative luminance image signal” indicate an identical signal.

The calculation unit 12 calculates an absolute luminance conversion value used when converting the relative luminance image signal that does not reflect information relating to the absolute luminance of the object into a signal that does reflect information relating to the absolute luminance of the object. The absolute luminance conversion value is expressed by the following Equation (1).

Absolute luminance conversion value=b₀/(bₛ×α) (1)

In Equation (1), b₀ is a luminance value of the observation illumination light, bₛ is a luminance value of the imaging illumination light, and α is the light reception condition coefficient.

The luminance value b₀ of the observation illumination light is detected by the illumination condition detection unit 2. The luminance value bₛ of the imaging illumination light is included in the imaging luminance information stored in the storage unit 4.

The light reception condition coefficient a is a coefficient relative to reference values of the aperture, shutter speed, and ISO sensitivity of the imaging device at the time of image capture of the multi-spectrum image, and corresponds to “information relating to the light reception condition at the time of image capture of the object”. More specifically, reference values of the aperture, shutter speed and ISO sensitivity of the imaging device are determined in advance, whereupon the proportions of the aperture, shutter speed and ISO sensitivity at the time of image capture of the multi-spectrum image relative to the respective reference values thereof are determined and calculated as the coefficient α. The coefficient α is calculated by a processing unit provided in the color reproduction device 100 but not shown in the figures following image capture of the multi-spectrum image, and stored in the storage unit 4. The reference values of the aperture, shutter speed and ISO sensitivity of the imaging device and data relating to the aperture, shutter speed and ISO sensitivity at the time of image capture of the multi-spectrum image may be stored in the storage unit 4 in advance and calculated by the calculation unit 12.

The conversion unit 11 calculates an absolute luminance image signal using the relative luminance image signal determined by the processing unit 7 and the absolute luminance conversion value calculated by the calculation unit 12 in accordance with the following Equation (2). The absolute luminance image signal takes an XYZ value of an XYZ calorimetric system, for example, in which the Y value corresponds to a luminance value (cd/m²) of the object to be reproduced.

Absolute luminance image signal=relative luminance image signal×absolute luminance conversion value (2)

By inserting Equation (1) into Equation (2), the absolute luminance image signal can be expressed by the following Equation (3).

Absolute luminance image signal=(relative luminance image signal/α)×(b₀/bₛ) (3)

In Equation (3), the relative luminance image signal is divided by the light reception condition coefficient α, thereby removing the effects of the light reception condition of the imaging device, and then multiplied by a ratio (b₀/bₛ) between the luminance value b₀ of the observation illumination light and the luminance value bₛ of the imaging illumination light. As a result, an absolute luminance image signal reflecting the luminance of the object when observed under the observation illumination light can be determined.

The conversion unit 13 performs color conversion processing on the absolute luminance image signal determined by the conversion unit 11 in accordance with a monitor profile of the image display monitor 1. The monitor profile may be stored in a storage device not shown in the figures in advance or obtained from the image display monitor 1 when the image display monitor 1 is connected to the color reproduction device 100. The image display monitor 1 displays an image corresponding to a display signal that has been subjected to color conversion processing by the conversion unit 13.

According to the color reproduction device of the first embodiment, a color conversion signal determined on the basis of an image signal of an object, color reproduction characteristic information, i.e. information obtained at the time of image capture of the object, and spectrum information of the observation illumination light illuminating the image display monitor 1 is converted into an image signal that reflects the luminance value of the object when observed under the observation illumination light on the basis of the luminance value of the observation illumination light, the luminance value of the imaging illumination light, and information relating to the light reception condition at the time of image capture of the object. Thus, an image that reflects not only the hues of the object when observed under the observation illumination light, but also the absolute luminance thereof, can be displayed on the image display monitor 1.

### Modified Example of First Embodiment

A modified example in which the absolute luminance conversion value is calculated using a different method will now be described. In this modified example, a color chart is photographed at the same time as the object, and the absolute luminance conversion value is calculated using data relating to the captured color chart. A color chart is an object constituted by patches having known chromaticity and spectral reflectances, such as a Macbeth Color Checker. At least one patch is required. It should be noted that the color chart may be photographed separately to the object rather than at the same time.

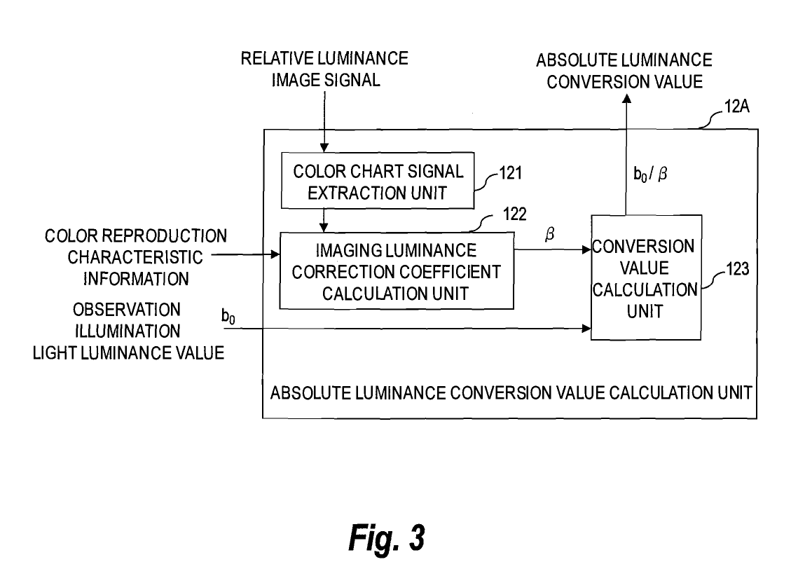

FIG. 3 is a view showing the constitution of an absolute luminance conversion value calculation unit 12A (to be referred to hereafter as calculation unit 12A) according to this modified example of the first embodiment. The calculation unit 12A comprises a color chart signal extraction unit 121 (to be referred to hereafter as extraction unit 121), an imaging luminance correction coefficient calculation unit 122 (to be referred to hereafter as calculation unit 122), and a conversion value calculation unit 123.

The extraction unit 121 extracts a color chart signal value, which is a signal value of the part capturing the color chart, from the relative luminance image signal determined by the processing unit 7. The color chart signal value may be expressed by the following Equation (4).

Color chart signal value=reference signal value of color chart×luminance value bₛ of imaging illumination light×light reception condition coefficient α (4)

Further, the reference signal value of the color chart is expressed by the following Equation (5).

Reference signal value of color chart=spectral reflectance of color chart×spectral characteristic of imaging device×spectrum of imaging illumination light (5)

The calculation unit 122 stores data relating to the spectral reflectance of the color chart and determines the reference signal value of the color chart using data relating to the spectral characteristic of the imaging device and data relating to the spectrum of the imaging illumination light in accordance with Equation (5). The spectral characteristic data of the imaging device and the spectrum data of the imaging illumination light are included in the color reproduction characteristic information stored in the storage unit 4. The color chart signal value extracted by the extraction unit 121 is then divided by the determined reference signal value of the color chart to determine an imaging luminance correction coefficient β (see the following Equation (6)).

Imaging luminance correction coefficient β=color chart signal value/reference signal value of color chart=luminance value bₛ of imaging illumination light×light reception condition coefficient α (6)

The conversion value calculation unit 123 determines the absolute luminance conversion value in accordance with the following Equation (7).

Absolute luminance conversion value=b₀/β (7)

As can be understood by inserting the imaging luminance correction coefficient β expressed by Equation (6) into Equation (7), the absolute luminance conversion value expressed by Equation (7) is equal to the absolute luminance conversion value expressed by Equation (1).

### Second Embodiment

In the color reproduction device 100 according to the first embodiment, processing is performed to reproduce the luminance of the object on the image display monitor 1 when placed under the observation illumination light. In actuality, however, the luminance range that can be displayed by the image display monitor 1 is limited, and it may therefore be impossible in certain cases to display the luminance of the object accurately.

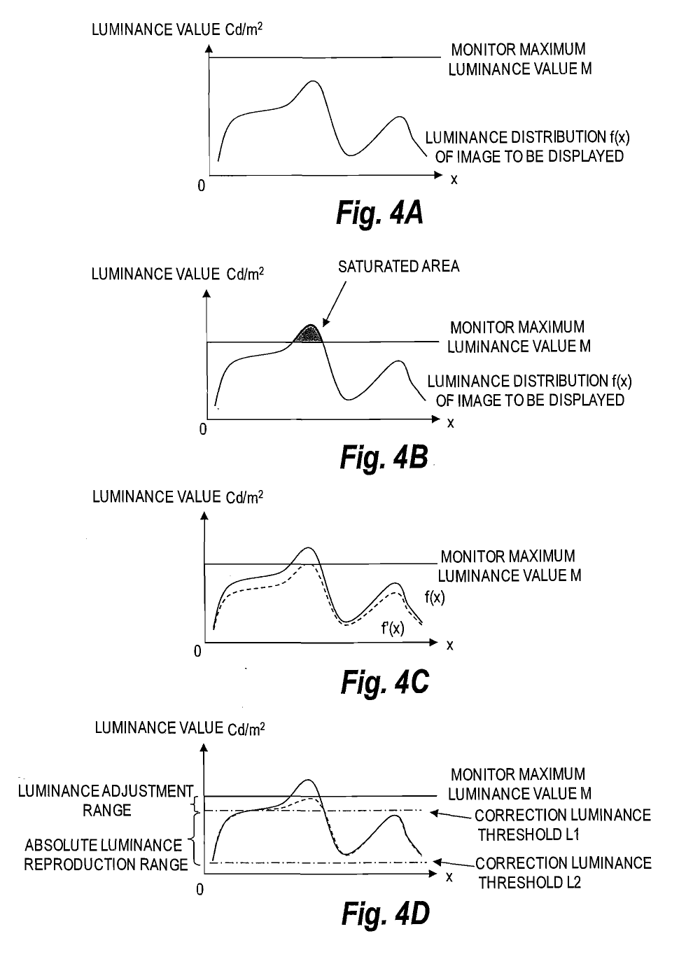

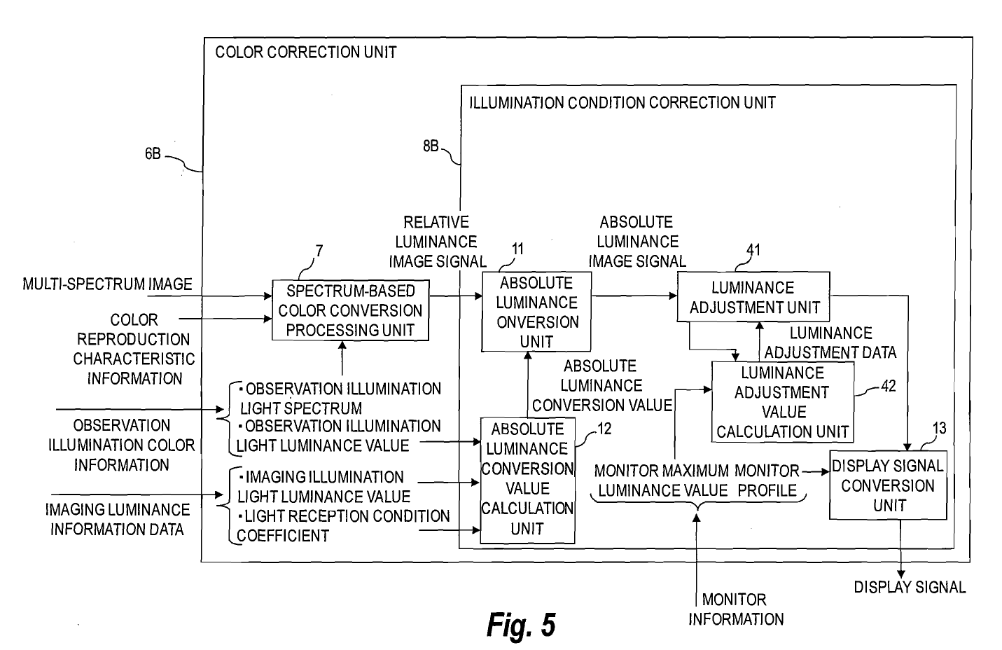

FIGS. 4A to 4D are views showing various luminance distribution patterns of an image displayed on the image display monitor 1. In the pattern shown in FIG. 4A, the luminance value of the displayed image is smaller than a maximum luminance value M of the image display monitor 1 in all image display positions. In this case, the absolute luminance of the object can be displayed by the image display monitor 1 as is. It should be noted that the maximum luminance value M of the image display monitor 1 is an upper limit value of the luminance values that can be displayed by the image display monitor 1.

In the pattern shown in FIG. 4B, the luminance value of the displayed image exceeds the maximum luminance value M of the image display monitor 1 in a part of the display positions. In this case, a luminance signal f (x) in a position where the luminance value exceeds the maximum luminance value M of the image display monitor 1 is saturated by the maximum luminance value M. It is effective in this case to detect a maximum luminance value of the luminance signal f (x) of the displayed image and perform luminance adjustment such that the maximum luminance value of the luminance signal f (x) is reduced to or below the maximum luminance value M of the image display monitor 1.

FIG. 4C is a view showing a luminance distribution when luminance adjustment is performed using a conventional method such that the maximum luminance value of the luminance signal f (x) is reduced to or below the maximum luminance value M of the image display monitor 1. In FIG. 4C, the luminance distribution prior to luminance adjustment is indicated by a solid line, and the luminance distribution following luminance adjustment is indicated by a dotted line. When luminance adjustment is performed as described above, the luminance values of the image to be displayed decrease as a whole, as shown by the dotted line in FIG. 4C, and as a result, the absolute luminance of the object cannot be displayed.

Hence, in a color reproduction device 100B according to the second embodiment, processing is performed to ensure that the absolute luminance of the main parts of the object is displayed even when a luminance value of the image to be displayed exceeds the maximum luminance value M of the image display monitor 1. For this purpose, a first correction luminance threshold L1 and a second correction luminance threshold L2 (L2<L1) are respectively provided within the displayable luminance range of the image display monitor 1. Luminance adjustment is then performed on the luminance values of the luminance signal f (x) that are larger than the first correction luminance threshold L1 and the luminance values of the luminance signal f (x) that are smaller than the second correction luminance threshold L2. In FIG. 4D, the luminance distribution prior to luminance adjustment is indicated by a solid line, and the luminance distribution following luminance adjustment by the color reproduction device 100B according to the second embodiment is indicated by a dotted line.

It should be noted that in the example shown in FIG. 4D, the luminance signal f (x) includes no luminance values that are smaller than the second correction luminance threshold L2, and therefore luminance adjustment is performed only on the luminance values that are larger than the first correction luminance threshold L1.

FIG. 5 is a view showing the constitution of a color correction unit 6B of the color reproduction device 100B according to the second embodiment. Identical constitutional elements to those of the color correction unit 6 shown in FIG. 2 have been allocated identical reference numerals, and detailed description thereof has been omitted.

The color correction unit 6B comprises the processing unit 7 and an illumination condition correction unit 8B (to be referred to hereafter as correction unit 8B). The correction unit 8B comprises the conversion unit 11, the calculation unit 12, the conversion unit 13, a luminance adjustment unit 41, and a luminance adjustment value calculation unit 42 (to be referred to hereafter as calculation unit 42).

The calculation unit 42 creates conversion table data for determining a post-adjustment luminance value on the basis of the absolute luminance image signal determined by the conversion unit 11 and the maximum luminance value M of the image display monitor 1.

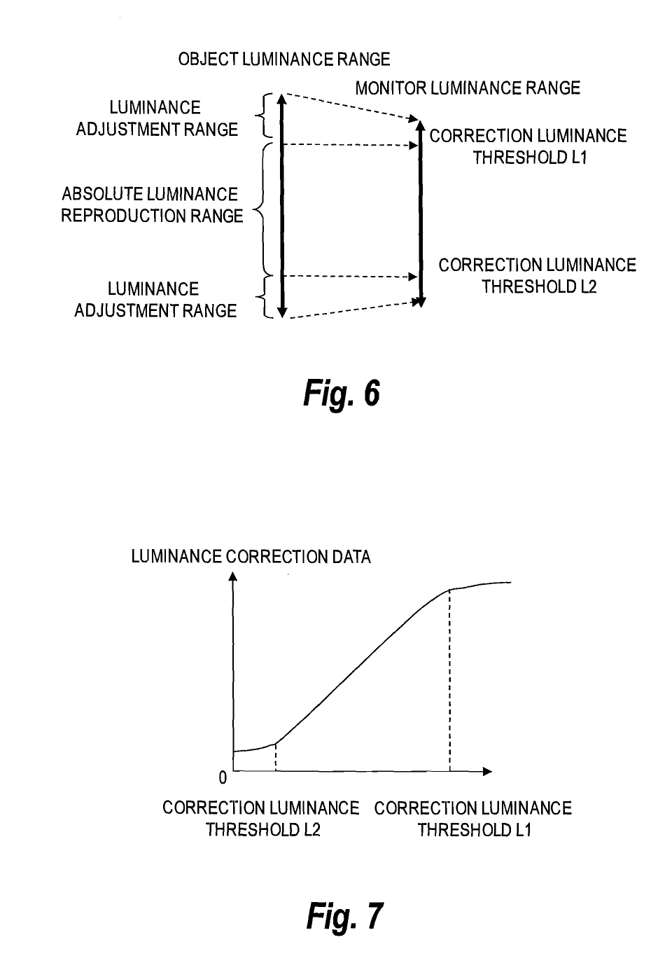

FIG. 6 is a view showing a relationship between a luminance range prior to luminance adjustment and a luminance range following luminance adjustment in a case where the luminance range of the object is wider than the displayable luminance range of the image display monitor 1. As described above, the first correction luminance threshold L1 and second correction luminance threshold L2 are provided, and luminance adjustment is performed on luminance values that are larger than the first correction luminance threshold L1 and luminance values that are smaller than the second correction luminance threshold L2. In other words, processing is performed to reduce the luminance values that are larger than the first correction luminance threshold L1 so that these luminance values fall to or below the maximum luminance value M of the image display monitor 1, and to increase the luminance values that are smaller than the second correction luminance threshold L2.

The first correction luminance threshold L1 is set at an appropriate value corresponding to the maximum luminance value M of the image display monitor 1. For example, a value obtained by subtracting a predetermined value from the maximum luminance value M of the image display monitor 1 is set as the first correction luminance threshold L1. Alternatively, a value obtained by multiplying a predetermined coefficient by the maximum luminance value M may be set as the first correction luminance threshold L1. The second correction luminance threshold L2 may be set at an appropriate value in advance.

FIG. 7 is a view showing a correspondence relationship between a pre-adjustment luminance value and a post-adjustment luminance value. The pre-adjustment luminance value is shown on the abscissa, and the post-adjustment luminance value is shown on the ordinate. As described above, a luminance value that is larger than the first correction luminance threshold L1 is converted to a smaller luminance value than the original luminance value, while a luminance value that is smaller than the second correction luminance threshold L2 is converted to a larger luminance value than the original luminance value. Luminance values that are equal to or larger than the second correction luminance threshold L2 and equal to or smaller than the first correction luminance threshold L1 remain the same following luminance adjustment.

The calculation unit 42 creates conversion table data having a pre-adjustment luminance value as an input value and a post-adjustment luminance value as an output value, as shown in FIG. 7.

Instead of the conversion table data described above, the calculation unit 42 may create a conversion coefficient for converting a pre-adjustment luminance value into a post-adjustment luminance value. In this case, the conversion coefficient used when the pre-adjustment luminance value is smaller than the second correction luminance threshold L2 is set at a value larger than 1, and the conversion coefficient used when the pre-adjustment luminance value is larger than the first correction luminance threshold L1 is set at a value smaller than 1. Further, the conversion coefficient used when the pre-adjustment luminance value is equal to or larger than the second correction luminance threshold L2 and equal to or smaller than the first correction luminance threshold L1 is set at 1.

The luminance adjustment unit 41 determines a post-adjustment absolute luminance image signal on the basis of the conversion table data created by the calculation unit 42 and the absolute luminance image signal determined by the conversion unit 11. The post-adjustment absolute luminance image signal is then input into the conversion unit 13.

According to the color reproduction device of the second embodiment, described above, when a luminance value of the absolute luminance image signal converted by the conversion unit 11 exceeds the maximum luminance value that can be displayed by the image display monitor 1, adjustment processing is performed to make the luminance value that exceeds the first correction luminance threshold L1 equal to or smaller than the maximum luminance value that can be displayed by the image display monitor 1. In so doing, the absolute luminance of the main parts of the object can be displayed while avoiding highlight detail loss in which the luminance value of the displayed image is saturated.

Further, when a luminance value of the absolute luminance image signal converted by the conversion unit 11 is smaller than the second correction luminance threshold L2, processing is performed to increase the luminance value that is lower than the second correction luminance threshold L2, and therefore shadow detail loss can be prevented while displaying the absolute luminance of the main parts of the object.

### Third Embodiment

In the color reproduction devices according to the first and second embodiments, processing is performed to reproduce the luminance of the object when placed under the observation illumination light. However, the entire display screen of the image display monitor 1 is rarely illuminated uniformly by the observation illumination light, and illumination unevenness usually exists. In the color reproduction device according to the third embodiment, illumination unevenness in the image display monitor 1 is detected, and the luminance of the image data to be displayed is corrected on the basis of the detected illumination unevenness.

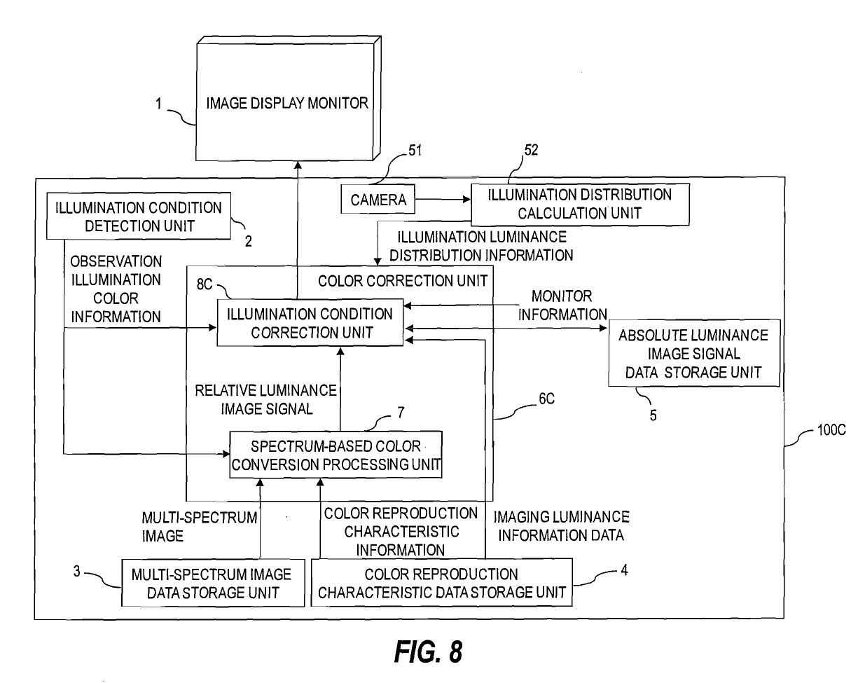

FIG. 8 is a view showing the constitution of a color reproduction device 100C according to the third embodiment. Constitutional elements that are identical to their counterparts in the color reproduction device 100 according to the first embodiment, shown in FIG. 1, have been allocated identical reference symbols, and detailed description thereof has been omitted. In addition to the constitution of the color reproduction device 100 according to the first embodiment, the color reproduction device 100C according to the third embodiment comprises a camera 51 and an illumination distribution calculation unit 52.

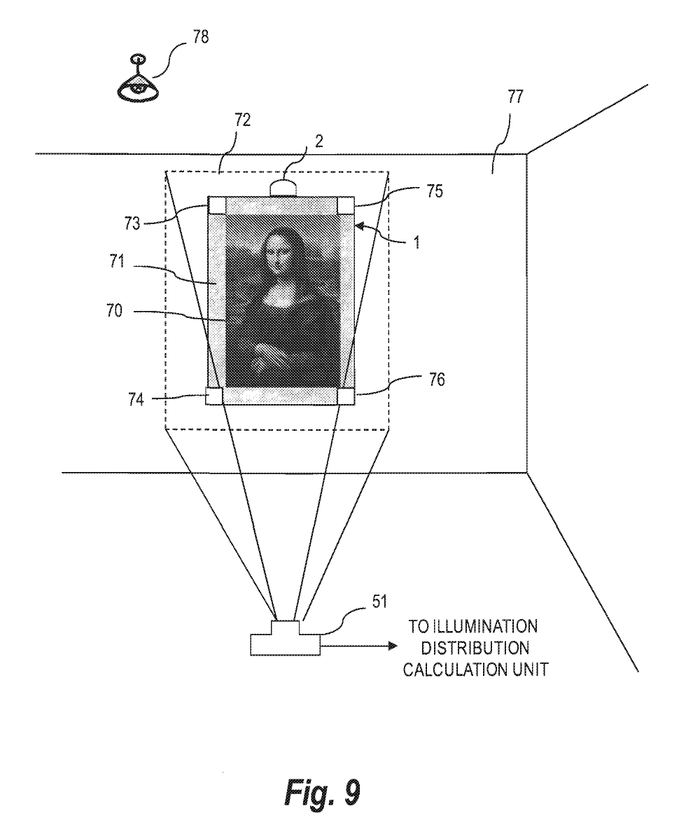

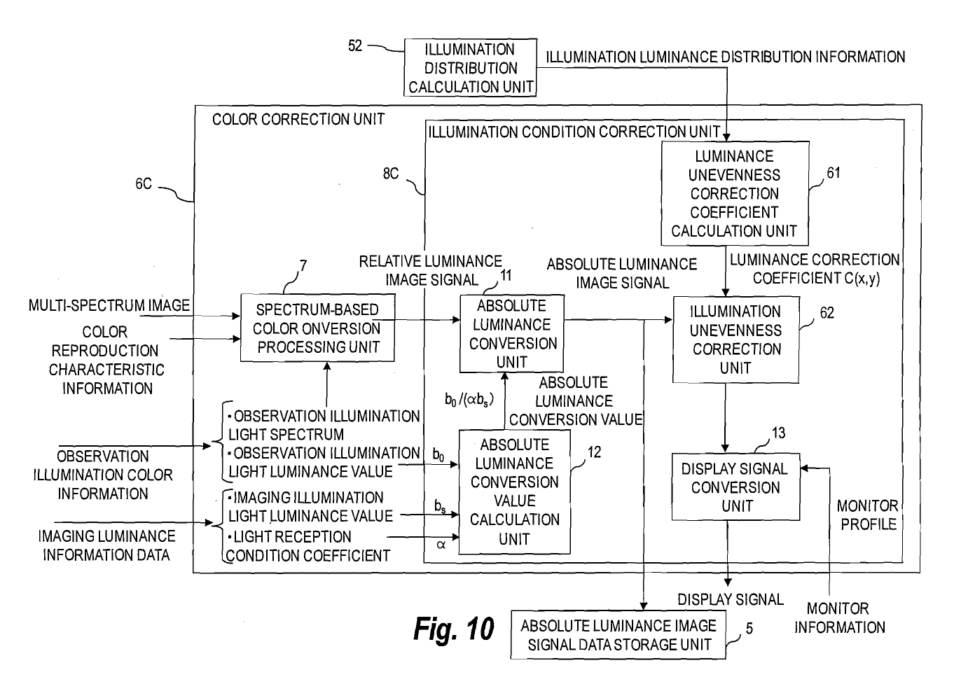

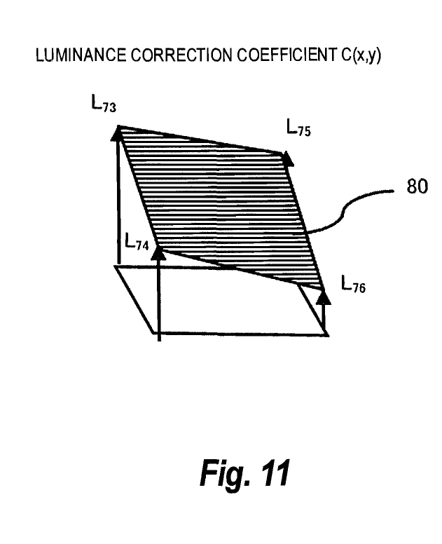

The camera 51 captures an image of a wider area than the image display monitor 1 in order to detect illumination unevenness in the image display monitor 1. FIG. 9 is a view showing the area captured by the camera 51. The image display monitor 1 is assumed to be hanging on a wall 77. As described above, the camera 51 captures an image of a wider area 72 than the image display monitor 1.

In the example shown in FIG. 9, the illumination sensor 2 serving as the illumination condition detection unit is disposed on top of the image display monitor 1.

The illumination distribution calculation unit 52 determines an illumination luminance distribution of an image display area 70 of the image display monitor 1 on the basis of the image captured by the camera 51. A method of determining the illumination luminance distribution will be described below using FIG. 9.

A plurality of detection areas for detecting the illumination luminance distribution are set on the image captured by the camera 51 in the vicinity of the image display area 70 of the image display monitor 1. In the example shown in FIG. 9, four detection areas 73 to 76 are set in the four corners of an outer frame 71 on the outside of the image display area 70.

The illumination distribution calculation unit 52 determines luminance values L₇₃, L₇₄, L₇₅, L₇₆ of the detection areas 73 to 76 on the basis of the image captured by the camera 51, and determines an overall luminance distribution of the image display area 70 on the basis of the determined luminance values. Information relating to the determined luminance distribution is transmitted to an illumination condition correction unit 8C of a color correction unit 6C.

It should be noted that luminance detection markers may be incorporated into the positions of the detection areas 73 to 76 of the outer frame 71 in advance. In this case, the illumination luminance distribution of the image display area 70 can be detected with a high degree of precision. Further, by setting detection areas in more than four locations, the illumination luminance distribution of the image display area 70 can be detected with a higher degree of precision.

FIG. 10 is a view showing the constitution of the color correction unit 6C. The color correction unit 6C comprises the processing unit 7 and the illumination condition correction unit 8C (to be referred to hereafter as correction unit 8C). The correction unit 8C comprises the conversion unit 11, the calculation unit 12, the conversion unit 13, a luminance unevenness correction coefficient calculation unit 61 (to be referred to hereafter as calculation unit 61), and an illumination unevenness correction unit 62 (to be referred to hereafter as correction unit 62).

The calculation unit 61 calculates a luminance correction coefficient C (x, y) in each pixel position (x, y) of the image display monitor 1 on the basis of the information relating to the illumination luminance distribution determined by the illumination distribution calculation unit 52. The pixel position (x, y) is a position coordinate of each pixel when the lower left of the image display area 70 is set as an origin (0, 0), a horizontal direction is set as an x axis, and a vertical direction is set as a y axis, for example.

FIG. 11 is a pattern diagram showing the luminance correction coefficient C (x, y) calculated by the calculation unit 61. A plane 80 including the luminance values L₇₃, L₇₄, L₇₅, L₇₆ represents the luminance correction coefficient C (x, y) in pattern form.

When an illumination device 78 is provided to the upper left of the image display monitor 1, as shown in FIG. 9, the luminance value L₇₃ of the illumination luminance distribution detection area 73 is large, whereas the luminance value L₇₆ of the illumination luminance distribution detection area 76 is small. Hence, the luminance correction coefficient C (x, y) is calculated to reproduce luminance values corresponding to the luminance distribution of the image display area 70, as shown by the plane 80 in FIG. 11. More specifically, the luminance correction coefficient C (x, y) is calculated by determining an expression that expresses the plane 80 shown in FIG. 11 on the basis of the illumination luminance distribution determined by the illumination distribution calculation unit 52. The plane 80 may be approximated by a planar expression or expressed by a higher order curved surface expression.

The correction unit 62 determines corrected luminance values by multiplying the luminance values of the display positions (x, y) of the image display area 70, obtained from the absolute luminance image signal determined by the conversion unit 11, by the luminance correction coefficient C (x, y) determined by the calculation unit 61. An image signal including the corrected luminance values is then transmitted to the conversion unit 13.

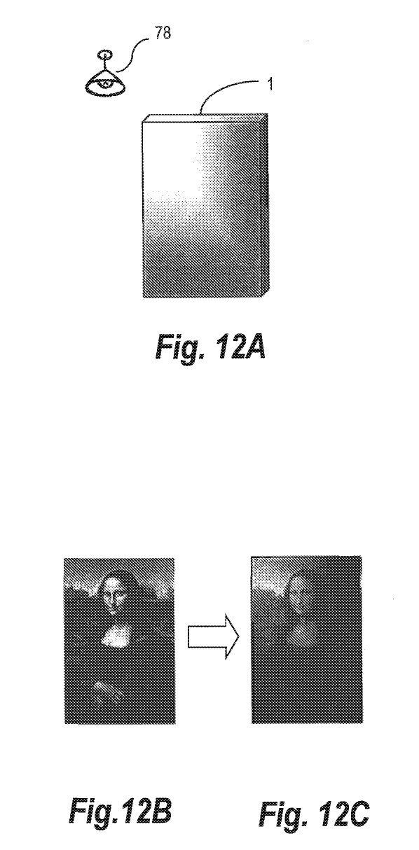

FIG. 12A is a view showing a state in which illumination unevenness occurs in the image display area 70 of the image display monitor 1 when the illumination device 78 is provided to the upper left of the image display monitor 1. FIG. 12B is a view showing the image prior to luminance correction corresponding to the illumination unevenness, and FIG. 12C is a view showing the image following luminance correction corresponding to the illumination unevenness, performed by the color reproduction device according to the third embodiment.

As shown in FIG. 12C, when luminance correction is performed in accordance with the illumination unevenness, the lower right area of the image display area has a smaller luminance value than the upper left area. In other words, by performing luminance correction in accordance with the illumination unevenness, the luminance distribution of the object when placed under the observation illumination light can also be reproduced.

According to the color reproduction device of the third embodiment, illumination unevenness in the observation illumination light illuminating the image display monitor 1 is detected, and correction corresponding to the detected illumination unevenness is performed on the luminance values converted to the absolute luminance image signal by the conversion unit 11. Thus, image display can be performed such that illumination unevenness is faithfully reproduced in addition to the luminance of the object when placed in the position of the image display monitor 1.

Modified examples in which the illumination luminance distribution of the image display area 70 of the image display monitor 1 is detected will be described below.

### First Modified Example of Third Embodiment

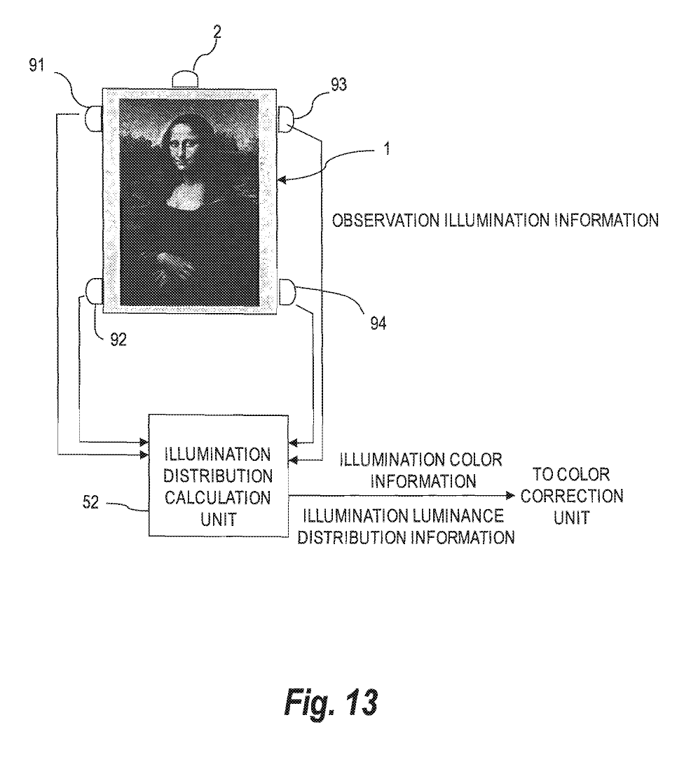

FIG. 13 is a view illustrating a modified example of a constitution for detecting the illumination luminance distribution of the image display area 70 of the image display monitor 1. A color reproduction device according to this modified example comprises illumination sensors 91 to 94 in place of the camera 51.

The illumination sensors 91 to 94 directly measure luminance in positions corresponding to the detection areas 73 to 76 described using FIG. 9. The illumination sensors 91 to 94 are preferably incorporated into the outer frame 71. Luminance values detected respectively by the illumination sensors 91 to 94 are transmitted to the illumination distribution calculation unit 52. The processing performed by the illumination distribution calculation unit 52, calculation unit 61, and correction unit 62 is identical to that of the case shown in FIG. 10.

It should be noted that the illumination sensors 91 to 94 need only detect luminance and not the illumination spectrum, and therefore smaller and less expensive sensors than the illumination sensor 2 may be used. Needless to say, however, sensors that are capable of detecting the illumination spectrum similarly to the illumination sensor 2 may be used as the illumination sensors 91 to 94. In this case, color unevenness may be detected in addition to luminance unevenness. Furthermore, the number of illumination sensors for detecting luminance is not limited to four, and a larger number of illumination sensors may be provided.

### Second Modified Example of Third Embodiment

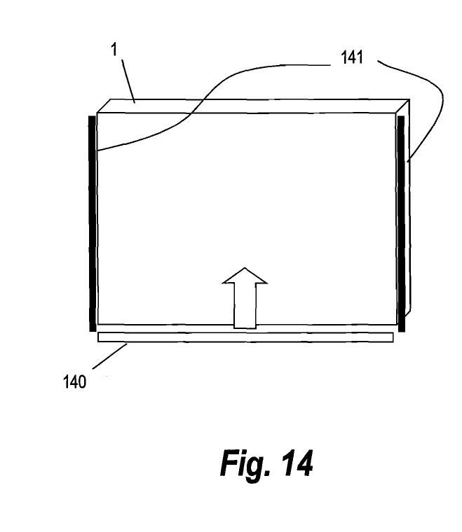

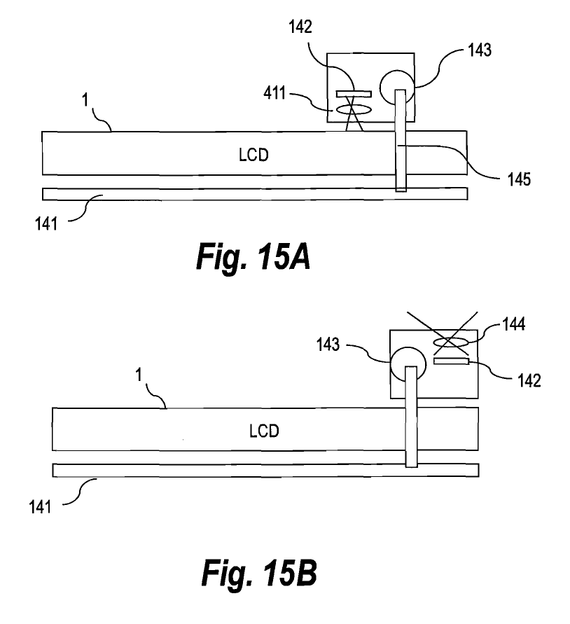

The illumination luminance distribution of the image display area 70 of the image display monitor 1 may be detected using a line sensor. FIG. 14 is a view showing an example in which illumination unevenness in the illumination luminance distribution of the image display area 70 of the image display monitor 1 is detected using a line sensor type illumination sensor 140. The line sensor type illumination sensor 140 comprises at least a line sensor 142 (see FIG. 15), and moves relative to the image display monitor 1 along a guide rail 141 in a direction indicated by an arrow in the figure. Thus, the luminance of the entire image display area of the image display monitor 1 can be measured. By measuring the luminance of the entire image display area of the image display monitor 1, the precision with which the correction coefficient C (x, y) is calculated can be improved in comparison with a case in which the luminance of the four illumination unevenness detection areas 73 to 76 is determined.

The line sensor type illumination sensor 140 comprises a detection position modification unit 143 for reversing a measurement direction of the line sensor 142, a directivity modification unit 144 for modifying the directivity of the sensor, and a detection position moving unit 145 for moving the line sensor 142 along the guide rail 141 (see FIG. 15). By reversing the measurement direction of the line sensor 142 using the detection position modification unit 143, the profile of the image display monitor 1 can be measured in addition to the illumination unevenness.

FIG. 15A is a view illustrating the orientation of the line sensor 142 when detecting the profile of the image display monitor 1. FIG. 15B is a view illustrating the orientation of the line sensor 142 when detecting the illumination unevenness. The line sensor 142 receives light from the image display monitor 1 when detecting the profile of the image display monitor 1, as shown in FIG. 15A, and receives light from the observation illumination light illuminating the image display monitor 1 when detecting the illumination unevenness, as shown in FIG. 15B.

When detecting the profile of the image display monitor 1, the directivity of the line sensor 142 is preferably reduced to improve the detection precision. Hence, when the profile of the image display monitor 1 is detected, the directivity modification unit 144 reduces the directivity of the line sensor 142 in comparison with a case in which the illumination unevenness is detected.

In order to ensure a favorable outer appearance, the line sensor type illumination sensor 140 is housed in the outer frame 71 normally and removed from the outer frame 71 only when the illumination unevenness is to be detected.

This invention is not limited to the first to third embodiments described above. For example, when a luminance value of the absolute luminance image signal converted by the conversion unit 11 exceeds the maximum luminance value that can be displayed by the image display monitor 1 in the second embodiment, adjustment processing is performed to make the luminance value that exceeds the first correction luminance threshold L1 equal to or smaller than the maximum luminance value that can be displayed by the image display monitor 1. This processing may also be applied to the color reproduction device according to the third embodiment.

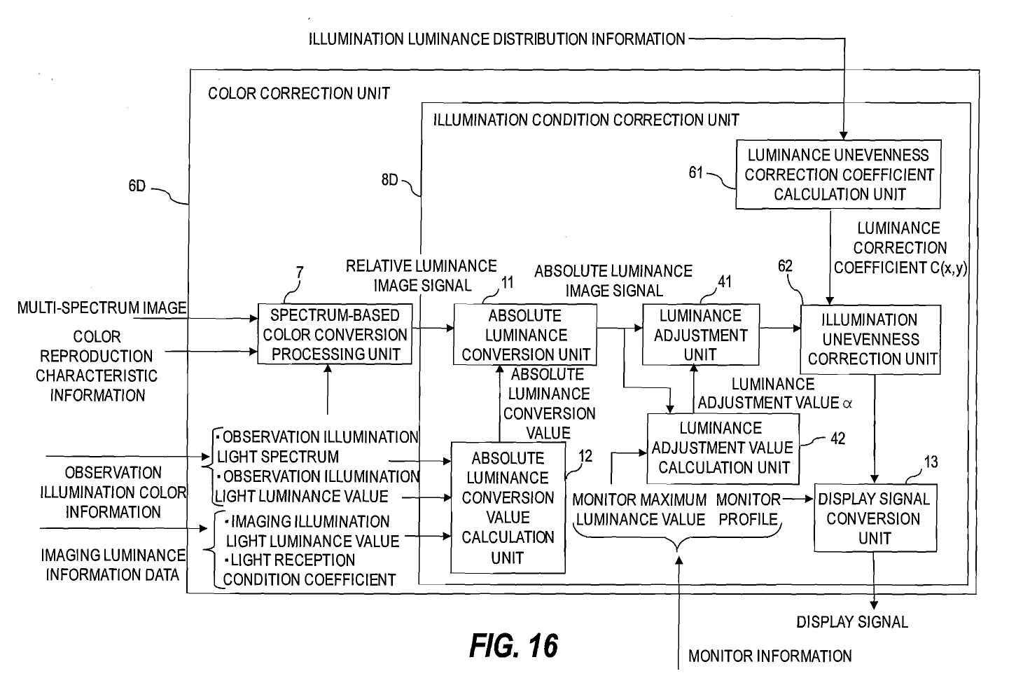

FIG. 16 is a view showing the constitution of a color correction unit 6D obtained by adding the luminance adjustment unit 41 and the luminance adjustment value calculation unit 42 to the constitution of the correction unit 8C in the color correction unit 6C according to the third embodiment, shown in FIG. 10. According to this constitution, similarly to the color reproduction device 100B of the second embodiment, when a luminance value of the absolute luminance image signal converted by the conversion unit 11 exceeds the maximum displayable luminance value of the image display monitor 1, adjustment processing is performed to make the luminance value that exceeds the first correction luminance threshold L1 equal to or smaller than the maximum displayable luminance value of the image display monitor 1. Thus, the absolute luminance of the main parts of the object can be displayed while avoiding highlight detail loss due to saturation of the luminance values of the displayed image.

Further, in the constitution shown in FIG. 16, when a luminance value of the absolute luminance image signal converted by the conversion unit 11 is smaller than the second correction luminance threshold L2, processing is performed to increase the luminance value that is smaller than the second correction luminance threshold L2. In this case, shadow detail loss can be prevented while displaying the absolute luminance of the main parts of the object.

In this first to third embodiments, detection of the observation illumination light may be performed by the illumination condition detection unit 2 at appropriate time intervals, for example every five minutes, and the processing described above may be performed by the color correction unit 6, 6B, 6C, 6D at each interval. With this method, image display can be performed in accordance with the newest observation illumination light.

The image display monitor 1 may be an RGB three primary color monitor or a multiple primary color monitor having four or more primary colors.

In the above description, it is assumed that the processing performed by the color reproduction device 100 is hardware processing, but this invention need not be limited to this constitution, and the processing may be performed by separate software, for example. In this case, the color reproduction device 100 comprises a CPU, a main storage device such as a RAM, and a computer-readable recording medium storing a program for realizing all or a part of the processing described above. Here, the program will be referred to as a color reproduction program. By having the CPU read the color reproduction program stored on the recording medium and execute the program, similar processing to that of the color reproduction device 100 described above is realized.

Here, the computer-readable recording medium is a magnetic disk, a magneto-optical disk, a CD-ROM, a DVD-ROM, semiconductor memory, or similar. Further, the color reproduction program may be distributed to a computer over a communication line, whereby the computer, having received the distributed program, executes the color reproduction program.

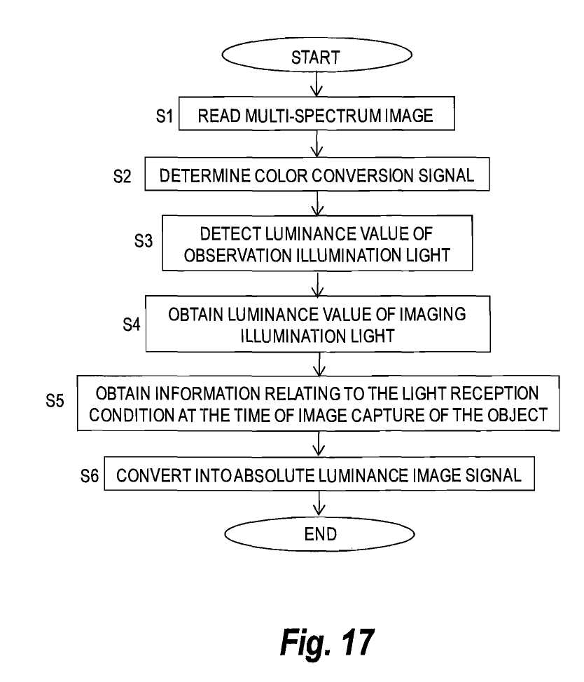

A processing procedure of the processing that is realized in the first embodiment when the CPU executes the color reproduction program will now be described with reference to FIG. 17. It should be noted that the processing of the second and third embodiments may be performed similarly using software.

First, in a step S1 of FIG. 17, a multi-spectrum image is read from the storage unit 3. In a step S2, a color conversion signal is determined by performing predetermined color conversion processing on the read multi-spectrum image on the basis of the color reproduction characteristic information, which is information obtained at the time of image capture of the object, and the spectrum of the observation illumination light. In a step S3, the luminance value of the observation illumination light detected by the illumination condition detection unit 2 is obtained.

In a step S4, the luminance value of the imaging illumination light is obtained from the storage unit 4. In a step S5, information relating to the light reception condition at the time of image capture of the object (the light reception condition coefficient a) is obtained from the storage unit 4. In a step S6, the color conversion signal determined in the step S2 is converted into an absolute luminance image signal reflecting the luminance value of the object when observed under the observation illumination light on the basis of the luminance value of the observation illumination light, the luminance value of the imaging illumination light, and the light reception condition information. The processing is then terminated.

In the step S6 of FIG. 17, the conversion processing described as a modified example of the first embodiment may be performed. More specifically, processing is performed to convert the color conversion signal determined in the step S2 into an absolute luminance image signal on the basis of the luminance value of the observation illumination light, a color chart signal obtained when the imaging device captures an image of a color chart having a known spectral reflectance, the spectral reflectance of the color chart, the spectral characteristic of the imaging device, and the spectrum of the imaging illumination light.

The entire contents of Japanese Patent Application P2008-4195 (filed on Jan. 11, 2008) are incorporated herein by reference.

What is claimed is:

1. A color reproduction device comprising:
an observation illumination light luminance value detection unit that detects a luminance value of an observation illumination light illuminating a monitor device for displaying an image;
an imaging illumination light luminance value storage unit that stores a luminance value of an imaging illumination light at the time of image capture of an object by an imaging device;
a light reception condition information storage unit that stores information relating to a light reception condition at the time of image capture of the object by the imaging device; and
a luminance conversion unit that converts a color conversion signal, which is determined on the basis of an image signal of the object, color reproduction characteristic information, which is information obtained at the time of image capture of the object, and a spectrum of the observation illumination light, into an image signal reflecting a luminance value of the object when observed under the observation illumination light on the basis of the luminance value of the observation illumination light, the luminance value of the imaging illumination light, and the information relating to the light reception condition.

2. A color reproduction device comprising:
an observation illumination light luminance value detection unit that detects a luminance value of an observation illumination light illuminating a monitor device for displaying an image;
an imaging illumination light luminance value storage unit that stores a luminance value of an imaging illumination light at the time of image capture of an object by an imaging device;
a light reception condition information storage unit that stores information relating to a light reception condition at the time of image capture of the object by the imaging device; and
a luminance conversion unit that converts a color conversion signal, which is determined on the basis of an image signal of the object, color reproduction characteristic information, which is information obtained at the time of image capture of the object, and a spectrum of the observation illumination light, into an image signal reflecting a luminance value of the object when observed under the observation illumination light on the basis of the luminance value of the observation illumination light, a color chart signal, which is a signal obtained when the imaging device captures an image of a color chart having a known spectral reflectance, the spectral reflectance of the color chart, a spectral characteristic of the imaging device, and a spectrum of the imaging illumination light.

3. The color reproduction device as defined in claim 1, further comprising a color conversion processing unit that generates the color conversion signal on the basis of the image signal of the object, the color reproduction characteristic information, which is information obtained at the time of image capture of the object, and the spectrum of the observation illumination light.

4. The color reproduction device as defined in claim 1, further comprising a luminance adjustment unit that, when a luminance value following luminance conversion by the luminance conversion unit exceeds a maximum displayable luminance value of the monitor device, performs luminance adjustment processing to make a luminance value that exceeds a first correction luminance threshold, of the luminance value following conversion processing by the luminance conversion unit, equal to or smaller than the maximum displayable luminance value of the monitor device.

5. The color reproduction device as defined in claim 4, wherein the luminance adjustment unit performs luminance adjustment processing on a luminance value that is smaller than a second correction luminance threshold, which is smaller than the first correction luminance threshold, of the luminance value following the conversion processing performed by the luminance conversion unit, to increase the luminance value.

6. The color reproduction device as defined in claim 1, further comprising:
an illumination unevenness detection unit that detects illumination unevenness in the monitor device illuminated by the observation illumination light; and
an illumination unevenness correction unit that performs correction corresponding to the illumination unevenness on the luminance value following the conversion processing performed by the luminance conversion unit.

7. The color reproduction device as defined in claim 6, wherein the illumination unevenness detection unit detects illumination unevenness in the monitor device on the basis of an image of the monitor device captured by the imaging device.

8. The color reproduction device as defined in claim 6, wherein the illumination unevenness detection unit comprises a plurality of illumination sensors provided around an image display area of the monitor device, and detects illumination unevenness in the monitor device on the basis of luminance values detected by the plurality of illumination sensors.

9. The color reproduction device as defined in claim 6, wherein the illumination unevenness detection unit comprises a line sensor, and detects illumination unevenness in the monitor device on the basis of a luminance value detected by having the line sensor scan an entire display screen of the monitor device.

10. The color reproduction device as defined in claim 1, wherein the image signal of the object is a multi-spectrum image signal.

11. The color reproduction device as defined in claim 2, further comprising a color conversion processing unit that generates the color conversion signal on the basis of the image signal of the object, the color reproduction characteristic information, which is information obtained at the time of image capture of the object, and the spectrum of the observation illumination light.

12. The color reproduction device as defined in claim 2, further comprising a luminance adjustment unit that, when a luminance value following luminance conversion by the luminance conversion unit exceeds a maximum displayable luminance value of the monitor device, performs luminance adjustment processing to make a luminance value that exceeds a first correction luminance threshold, of the luminance value following conversion processing by the luminance conversion unit, equal to or smaller than the maximum displayable luminance value of the monitor device.

13. The color reproduction device as defined in claim 12, wherein the luminance adjustment unit performs luminance adjustment processing on a luminance value that is smaller than a second correction luminance threshold, which is smaller than the first correction luminance threshold, of the luminance value following the conversion processing performed by the luminance conversion unit, to increase the luminance value.

14. The color reproduction device as defined in claim 2, further comprising:
an illumination unevenness detection unit that detects illumination unevenness in the monitor device illuminated by the observation illumination light; and
an illumination unevenness correction unit that performs correction corresponding to the illumination unevenness on the luminance value following the conversion processing performed by the luminance conversion unit.

15. The color reproduction device as defined in claim 14, wherein the illumination unevenness detection unit detects illumination unevenness in the monitor device on the basis of an image of the monitor device captured by the imaging device.

16. The color reproduction device as defined in claim 14, wherein the illumination unevenness detection unit comprises a plurality of illumination sensors provided around an image display area of the monitor device, and detects illumination unevenness in the monitor device on the basis of luminance values detected by the plurality of illumination sensors.

17. The color reproduction device as defined in claim 14, wherein the illumination unevenness detection unit comprises a line sensor, and detects illumination unevenness in the monitor device on the basis of a luminance value detected by having the line sensor scan an entire display screen of the monitor device.

18. The color reproduction device as defined in claim 2, wherein the image signal of the object is a multi-spectrum image signal.

19. A color reproduction method comprising:
obtaining a luminance value of an observation illumination light illuminating a monitor device for displaying an image;
obtaining a luminance value of an imaging illumination light at the time of image capture of an object by an imaging device;
obtaining information relating to a light reception condition at the time of image capture of the object by the imaging device; and
converting a color conversion signal, which is determined on the basis of an image signal of the object, color reproduction characteristic information, which is information obtained at the time of image capture of the object, and a spectrum of the observation illumination light, into an image signal reflecting a luminance value of the object when observed under the observation illumination light on the basis of the luminance value of the observation illumination light, the luminance value of the imaging illumination light, and the information relating to the light reception condition.

20. A color reproduction method comprising:
obtaining a luminance value of an observation illumination light illuminating a monitor device for displaying an image;
obtaining a luminance value of an imaging illumination light at the time of image capture of an object by an imaging device;
obtaining information relating to a light reception condition at the time of image capture of the object by the imaging device; and
converting a color conversion signal, which is determined on the basis of an image signal of the object, color reproduction characteristic information, which is information obtained at the time of image capture of the object, and a spectrum of the observation illumination light, into an image signal reflecting a luminance value of the object when observed under the observation illumination light on the basis of the luminance value of the observation illumination light, a color chart signal, which is a signal obtained when the imaging device captures an image of a color chart having a known spectral reflectance, the spectral reflectance of the color chart, a spectral characteristic of the imaging device, and a spectrum of the imaging illumination light.

21. A computer-readable recording medium storing a color reproduction program to be executed on a computer, wherein the color reproduction program comprises:
obtaining a luminance value of an observation illumination light illuminating a monitor device for displaying an image;
obtaining a luminance value of an imaging illumination light at the time of image capture of an object by an imaging device;
obtaining information relating to a light reception condition at the time of image capture of the object by the imaging device; and
converting a color conversion signal, which is determined on the basis of an image signal of the object, color reproduction characteristic information, which is information obtained at the time of image capture of the object, and a spectrum of the observation illumination light, into an image signal reflecting a luminance value of the object when observed under the observation illumination light on the basis of the luminance value of the observation illumination light, the luminance value of the imaging illumination light, and the information relating to the light reception condition.

22. A computer-readable recording medium storing a color reproduction program to be executed on a computer, wherein the color reproduction program comprises:
obtaining a luminance value of an observation illumination light illuminating a monitor device for displaying an image;
obtaining a luminance value of an imaging illumination light at the time of image capture of an object by an imaging device;
obtaining information relating to a light reception condition at the time of image capture of the object by the imaging device; and
converting a color conversion signal, which is determined on the basis of an image signal of the object, color reproduction characteristic information, which is information obtained at the time of image capture of the object, and a spectrum of the observation illumination light, into an image signal reflecting a luminance value of the object when observed under the observation illumination light on the basis of the luminance value of the observation illumination light, a color chart signal, which is a signal obtained when the imaging device captures an image of a color chart having a known spectral reflectance, the spectral reflectance of the color chart, a spectral characteristic of the imaging device, and a spectrum of the imaging illumination light.
